(19) United States
(12) Patent Application Publication
(10) Pub. No.: US 2012/0155139 A1
(43) Pub. Date: Jun. 21, 2012

(54) Electrical Energy Conversion Circuit Device

(75) Inventor: Ulrich Boeke, Langerwehe (DE)

(73) Assignee: KONINKLIJKE PHILIPS ELECTRONICS N.V., Eindhoven (NL)

(21) Appl. No.: 13/390,701

(22) PCT Filed: Sep. 1, 2010
(86) PCT No.: PCT/IB2010/053918

§ 371 Date: Feb. 16, 2012

(30) Foreign Application Priority Data
Sep. 7, 2009 (EP) 09169576.7

(51) Int. Cl. H02M 7/537; H02M 3/158

(52) U.S. Cl. 363/131; 323/311

(57) ABSTRACT

The present invention is related to an electrical energy conversion circuit device (190), a method (600) of operating an electrical energy conversion circuit device, an electrical apparatus (500) and a computer program. The circuit device (190) allows earth connection and comprises two parallel connected buck-boost converters for converting a direct input voltage (110) into a direct output voltage (120). The converters are adapted to generate two phase-shifted currents (131, 141) that are received by an output capacitor (160). Due to the phase-shift, a current ripple is reduced. The direct output voltage (120) and the direct input voltage (110) preferentially have a common potential (114) and are of opposite polarities. Therefore, a second voltage of high magnitude, the sum of the direct input voltage (110) and the direct output voltage (120) is also provided.

### FIELD OF THE INVENTION

The invention relates to an electrical energy conversion circuit device, an electrical apparatus, a method of operating an electrical energy conversion circuit device and a computer program. In particular, the invention relates to converting electrical energy provided by a photovoltaic module.

### BACKGROUND OF THE INVENTION

United States Patent Application Publication US 2008/0266919 A1 discloses a circuit apparatus for a transformerless conversion of an electric direct voltage into an alternating voltage. The circuit apparatus comprises two buck-boost choppers, wherein a second buck-boost chopper is connected downstream of a first buck-boost chopper. The first of the two buck-boost choppers is adapted to convert an input voltage provided by a first electrical energy source, such as a photovoltaic module, into a first intermediate direct voltage. A second of the two buck-boost choppers is adapted to convert the first intermediate direct voltage into a second intermediate direct voltage. Both the first and the second intermediate voltage are filtered by a respective intermediate capacitor. The two intermediate capacitors are connected in series via a joint connection point which is connected to earth or a neutral point, respectively. The energy source providing the input voltage is also connected to earth or the neutral point, respectively. The circuit apparatus further comprises a half-bridge for converting the first and the second intermediate direct voltage into an alternating voltage. The alternating voltage is filtered by a filtering circuit of the circuit apparatus before being fed into an electrical grid.

### SUMMARY OF THE INVENTION

It is an object of the present invention to provide a high efficiency electrical energy conversion circuit device that allows an earth connection.

In a first aspect of the present invention an electrical energy conversion circuit device for converting a direct input voltage into a direct output voltage is presented, wherein the electrical energy conversion circuit device comprises:
a positive contact and a common contact of constant potential for receiving the direct input voltage,
a first buck-boost converter connected to the positive contact and the common contact and adapted to generate a first intermediate current in dependence of a first control signal,
a second buck-boost converter connected in parallel to the first buck-boost converter and adapted to generate a second intermediate current in dependence of a second control signal,
an output capacitor adapted to receive the first and the second intermediate current and to generate the direct output voltage in dependence of the first and the second intermediate current,
a controller adapted to provide the first control signal and the second control signal such that the first and the second intermediate current are phase shifted to each other, thereby regulating the direct output voltage in magnitude.

The invention is based on the recognition that the two buck-boost choppers of the above mentioned prior art circuit apparatus, which each charge a respective own intermediate capacitor, cause a poor efficiency of the circuit apparatus, in particular due to the high current ripples they effect. Due to high current ripples, which do not increase the effective current or voltage, respectively, high peak currents cause energy losses, in particular in the switches, and electrically stress both passive and active components of the circuit. Additionally, high current ripples significantly reduce the lifetime of the circuit apparatus since they also cause a mechanical stress upon active devices of the circuit apparatus, such as semiconductor power switches, and passive devices, such as diodes, chokes or capacitors of the circuit apparatus. Moreover, high current ripples require larger capacitors, which are adapted to withstand the high current ripples. Large capacitors, however, result in a heavier and more expensive circuit apparatus, which is generally disadvantageous.

Furthermore, due to the series connection of the two buck-boost choppers of the prior art circuit apparatus, the first of the two serial connected buck-boost choppers prior art circuit apparatus must be dimensioned for transfer of a power substantially equivalent to 100% of the rated power of the entire prior art circuit apparatus. Only the second of the two buck-boost choppers of the prior art circuit apparatus can be dimensioned for transfer of a power less than 100% of the rated power of the entire prior art circuit apparatus. Therefore, the prior art circuit apparatus exhibits a low power density.

The proposed electrical energy conversion circuit device (in the following also referred to as circuit device) overcomes the aforementioned deficiencies of the prior art circuit apparatus.

Since the controller is adapted to control the first and the second buck-boost converter such that the first and the second intermediate current are phase-shifted to each other, a current ripple of the sum of the first and the second intermediate current is reduced. It shall be understood that the circuit device of the present invention is set up such that the output capacitor receives that sum of the first and the second intermediate current. Due to the phase-shift, during one time period of a switching period, the first intermediate current is rising and the second intermediate current is falling. This operation mode, which is also referred to as interleaved operation of the first and the second buck-boost converter, has the advantage that a current stress effective at the output capacitor and an input capacitor providing the direct input voltage can be reduced by 60% compared to a single buck-boost converter converting the same amount of power.

Both the first and the second intermediate current originate from the source of the direct input voltage, and thereby from the input capacitor, and act on circuit components of the buck-boost converters, such as chokes, resistors, capacitors, switches, diodes as well as on the output capacitor. Therefore, the reduced current ripple has a plurality of interrelated advantages: First, the losses of the first and the second buck-boost converter are reduced. Second, components of the buck-boost converter do not have to be overdimensioned in order to withstand a high current ripple. Third, ripples of the direct output voltage and the direct input voltage are reduced. Therefore, the capacitances of the output capacitor and/or the input capacitor can be reduced, resulting in smaller and therefore more inexpensive capacitors. These effects of the reduced current ripple also result in an increased lifetime of the circuit device of the present invention.

Furthermore, due to the parallel connection of the first and the second buck-boost converter, the circuit device exhibits a high power density. Both the first and the second buck-boost converter can be dimensioned for transfer of a power substantially equivalent to 50% of a rated power of the circuit device.

The invention is based on the further recognition that a negative pole of a source of the direct input voltage is often advantageously connected to earth/ground in order to avoid performance degradation of a source providing the direct input voltage. For instance, thin film photovoltaic modules, which preferentially serve as the source of the direct input voltage, promise significant cost reduction in respect to conversion of solar radiation into electrical energy. Most thin film photovoltaic modules, however, require an earth connection to avoid performance degradation. For many further sources of the direct input voltage, it is either advantageous or even required that an earth or ground connection is provided. A requirement of an earth/ground connection may have physical reasons, but also may be a specification of a standard.

Since the circuit device of the present invention comprises the common contact of constant potential for receiving the input voltage, a source providing that input voltage is consequently also connected to the common contact. This has a first advantage that a plurality of different sources can serve as the source for the direct input voltage. A second advantage is that a high efficiency of a source of the direct input voltage, such as a thin-film photovoltaic module, is achieved. Therefore, the efficiency of an arrangement comprising a source of the direct input voltage and the circuit device is increased.

The direct input voltage may be supplied by any appropriate source, for example by a fuel cell, by a rectifier connected upstream of the circuit device, a battery, or any generator of a direct voltage. Preferentially, the direct input voltage is supplied by a photovoltaic module. In most cases, there is connected an input capacitor between the positive contact and the common contact. The input capacitor may either come as an external capacitor connected between the source and the circuit device or alternatively as an integrated output capacitor of the source or, respectively, as an internal input capacitor of the electrical energy conversion circuit device. It is also possible that both the source comprises an integrated output capacitor and the circuit device comprises an internal input capacitor that act together as the input capacitor.

Within the scope of depicting the present invention, the wording ‘constant potential’ refers to substantially time constant electrical potential. Slight deviations of the constant potential, such as 1 V, 5 V or 10 V shall still be considered as being constant. It shall further be understood that the wording ‘contact’ does not only mark a specific connection point but can also refer to a signal line or the like with a plurality of connection points, wherein the connection line spatially exhibits a substantially constant potential. Furthermore it shall be understood that the wordings ‘positive contact’ and the latter introduced wording ‘negative contact’ do not necessarily imply that their electrical potential is indeed positive or negative, respectively, in respect to the potential of the common contact. The electrical potential of the positive contact may be positive or negative and the electrical potential of the negative contact may also be positive or negative. Further, both the negative and the positive contact may exhibit a same polarity or a different polarity.

As elaborated above, the common contact of constant potential is preferentially connected to earth or ground, respectively. This has the advantage that the source providing the direct input voltage is also connected to earth or ground, respectively.

The first and the second buck-boost converter are connected to the positive contact and the common contact for processing the direct input voltage. Within the scope of depicting the present invention, the wording ‘buck-boost converter’ refers to a power electronic converter adapted to convert a first direct voltage into a second direct voltage, wherein the second direct voltage can either be smaller in magnitude, as great as or greater than the first direct voltage. The first and the second buck-boost converter of the circuit device of the present invention each comprise at least a choke, a switch and a diode. It shall be understood that within the scope of depicting the present invention, the wording ‘choke’ also refers to an inductor or a coil or any other wordings for an electrical choke.

It shall further be understood that within the scope of depicting the present invention, the wording ‘parallel’ indicates that two units connected in parallel have identical input and output connection points in respect to a power flow. Parallel connected units may, however, receive different control signals. A respective unit of parallel connected units also may additionally exhibit a further current and/or voltage tap. In particular, the parallel connected first and second buck-boost converter of the circuit device of the present invention are both connected to the positive contact and the common contact on their respective input side and, in respect to their respective output side, both connected to the output capacitor. Both the first and the second buck-boost converter supply the first or the second, respectively, intermediate current to the same output capacitor.

In a preferred embodiment, the first and the second buck-boost converter are identical in respect to their topology and components. This facilitates the control of the two buck-boost converters.

It is also preferred that both the first and the second buck-boost converter are dimensioned for transfer of a power substantially equivalent to 50% of a rated power of the circuit device.

In yet a preferred embodiment, the first and the second buck-boost converter are bidirectional buck boost converters. This has the advantage that energy can be transferred both from the input capacitor to the output capacitor and from the output capacitor to the input capacitor.

Preferentially, the controller is adapted to regulate the direct output voltage with an outer control loop and to regulate the first and the second buck-boost converter with an inner control loop. Therefore, the first and the second intermediate current are regulated in dependence of a desired magnitude value of the direct output voltage.

Preferentially, the controller is adapted to control the first and the second intermediate current such that the first and the second intermediate current are substantially equal in average magnitude. This facilitates executing a control such that the current ripple is reduced.

In one embodiment, the controller is adapted to control the first and the second buck-boost converter such that the direct input voltage and the direct output voltage are substantially equal in magnitude. In this embodiment, the phase-shift between the first and the second intermediate current is about 180°.

In other embodiments, the controller is adapted to control the first and the second buck-boost converter such that the direct input voltage and the direct output voltage are of unequal magnitude. In these embodiments, the phase-shift preferentially differs from 180°, wherein the current ripple remains being reduced.

In a preferred embodiment, the controller is adapted to control the first and the second buck-boost converter such that the direct output voltage is substantially constant in magnitude.

Preferentially, the capacitance of the output capacitor is dimensioned such that a ripple of the direct output voltage values no more than 10%, preferentially no more than 5%. It shall be understood that the output capacitor of the circuit device of the present invention may also be realized by a capacitor of a load connected in parallel to the output capacitor. In that context, the capacitance of output capacitor of the circuit device may be negligible small compared to a capacitance of the load.

In a preferred embodiment, the output capacitor is a film capacitor.

In an alternative embodiment, the output capacitor is an electrolytic capacitor. An electrolytic capacitor has the advantage of a high capacity density; however, an operation temperature of an electrolytic capacitor increases with increased current ripple which results in a decreased life-time. As the circuit device provides a current with a reduced current ripple to the output capacitor, an electrolytic capacitor can still be employed.

Preferentially, the circuit device of the present invention is used for supplying a direct current (DC) load, such as a local DC grid, connected to the output capacitor of the circuit device. Such DC grids are in particular present in households or transportation vehicles, such as cars, trains, ships and aircrafts.

The DC load can also be a resistive load. In one embodiment, the circuit device of the present invention is used for supplying a battery. In other embodiments, the DC load is an electrical illuminating system, an air conditioning system or a heating system.

The DC load supplied by the direct output voltage discharges the output capacitor. The controller is preferentially adapted to monitor the direct output voltage and to control the required power transfer from the input capacitor to the output capacitor.

In a particularly preferred embodiment of the circuit device, the output capacitor is connected between the common contact and a negative contact of the electrical energy conversion circuit device and the generated direct output voltage is of opposite polarity compared to a polarity of the direct input voltage.

This embodiment has the advantage that a second output voltage of a high magnitude is produced, namely the voltage across the positive contact and the negative contact. The second output voltage has thus a magnitude that is substantially equal to the sum of the magnitude of the direct input voltage and the magnitude of the direct output voltage. The second output voltage is available for a load.

Preferentially, further circuit means for processing the second output voltage are connected to downstream of the positive contact and the negative contact.

In a further particularly preferred embodiment, the circuit device additionally comprises a single phase inverter connected downstream of the parallel connected first and second buck-boost converter between the positive contact and the negative contact.

This embodiment is advantageous since the circuit device is now adapted to supply electrical energy not only to a DC grid but also to an alternating current (AC) grid or any other AC load, such as an electrical machine. Therefore, if the energy provided by the source of the direct input voltage exceeds the demands of a DC load connected to the output capacitor of the circuit device, remaining energy can be supplied to the AC load, such as an AC grid, connected to the single phase inverter. Preferentially, the single phase inverter is thus connected to an AC grid, for example a 230 V AC grid or a 120 V AC grid. Preferentially, the single phase inverter is connected to an AC grid via a filtering choke for filtering a high frequency component of an alternating output current of the single phase inverter.

In a preferred embodiment, the common contact is connected to a neutral contact of the AC grid connected to the single phase inverter. Since the single phase inverter is connected between the positive contact and the negative contact, its effective input voltage is the sum of the direct input voltage and the direct output voltage.

In a preferred embodiment, the controller of the circuit device is adapted to provide third control signals to the single phase inverter for controlling the single phase inverter.

In one embodiment, the controller is adapted to control the transferred power of the single phase inverter. This embodiment is preferred, if the output voltage of the single phase inverter is already fixed, for instance due to connection with a differently regulated AC grid (also referred to as AC mains).

In another embodiment, the controller is adapted to control an output voltage of the single phase inverter. This embodiment is preferred, if a passive AC-load is connected to the single phase inverter.

Preferentially, the third control signals are pulse width modulated (PWM) signals. In one embodiment, the controller is adapted to generate the third control signals by means of a current tolerance band control. In another embodiment, the controller is adapted to generate the third control signals by means of a comparison of triangular signal or sawtooth signal with a reference signal, preferentially a sinusoidal reference signal.

Preferentially, the controller is adapted to control the first and the second buck-boost converter and the single phase inverter in a plurality of control modes. In a first control mode of the controller, energy is transferred from the source of the direct input voltage to a DC load connected to the output capacitor only. In a second control mode, energy is transferred from the source of the direct input voltage to an AC load connected to the single phase inverter. In a third control mode, energy is transferred from the source of the direct input voltage to the DC load and the AC load.

Preferentially, the single phase inverter of the electrical energy conversion circuit device is adapted to operate as a single phase rectifier. Therefore, the single phase inverter allows a bidirectional energy flow.

This embodiment is advantageous since a local DC load connected to the output capacitor of the circuit device can be supplied by either the source of the direct input voltage or an AC grid connected to the single phase inverter operating as a single phase rectifier or by both the AC grid and the source of the direct input voltage, if the source of the direct input voltage does not supply sufficient energy to the DC load.

Preferentially, the single phase inverter is adapted to operate as a controlled single phase rectifier controlled by the controller of the circuit device.

In a preferred embodiment, during a forth control mode of the controller of the circuit device, energy is transferred to the DC load connected to the output capacitor from both the source of the direct input voltage and the AC grid connected to the single phase inverter. Preferentially, the source of the direct input voltage is a sustainable source, such as a fuel cell, a photovoltaic module, a rectifier connected downstream of a wind turbine. Preferentially, the AC grid is a 230 V grid or a 120 V grid.

A further advantage of this embodiment is that a DC-Load, which is normally supplied via an AC grid, must not be equipped with an own rectifier or a power factor correction unit since they can be supplied with the direct output voltage of the circuit device. Therefore, costs of many DC-Loads can be reduced.

In yet a further embodiment, the controller of the circuit device is adapted to operate the source of the direct input voltage in a point of maximum power (maximum power point tracking; MPPT). This has the advantage that a maximum of available energy of the source of the direct input voltage, for instance an array of photovoltaic modules or a wind turbine, is used. This embodiment is particularly preferred, if a substantially constant electrical load is to be supplied by a source of the input voltage that may exhibit a fluctuating power curve. A positive or negative difference of the fluctuating power of the source and the substantially constant power of the electrical load is provided by or, respectively, supplied to the AC grid connected to the single phase inverter.

In another preferred embodiment, the circuit device comprises a multi phase inverter connected downstream of the parallel connected first and second buck-boost converter between the positive contact and the negative contact. Generally speaking, this embodiment yields similar advantages as the embodiment of the circuit device does, where a single phase inverter is arranged. Further and in particular, this embodiment has identical or similar modes of carrying it out as described above.

However, in this embodiment of the circuit device, the multi phase inverter is preferentially connected to a multi phase AC grid, or to a multiphase AC load, such as an electrical machine. The multi-phase inverter is in particular preferred over the single phase inverter, if a large amount of power, such as 5 kW or more is to be transferred via the circuit device. In a preferred embodiment, the multi phase inverter is a three phase inverter. Preferentially, the three phase inverter is connected to a three phase AC grid such as a 208 V AC grid or a 400 V AC grid.

In a preferred embodiment, the controller is adapted to provide forth control signals to the multi phase inverter. Preferentially, the controller of the circuit device is adapted to generate the forth control signals by means of a space vector modulation. However, in other embodiments, the controller is adapted to generate the forth control signals by means of current tolerance band control or by means of comparison of reference signal with a triangular or sawtooth signal, such as natural sampling.

In yet a preferred embodiment, the multi phase inverter of the electrical energy conversion circuit device is adapted to operate as a multi phase rectifier. Therefore, the multi phase inverter allows bidirectional energy flow.

This embodiment is particularly advantageous since a local DC load connected to the output capacitor of the circuit device can be supplied by either the source of the direct input voltage or a multi phase AC grid connected to the multi phase inverter operating as a multi phase rectifier or by both the multi phase AC grid and the source of the direct input voltage. In a preferred embodiment, during the forth control mode of the controller of the circuit device, energy is transferred to the DC load connected to the output capacitor from both the source of the direct input voltage and the multi phase AC grid. Preferentially, the source of the direct input voltage is a sustainable source, such as a fuel cell, a photovoltaic module, a rectifier connected downstream of a wind turbine. Preferentially, the multi phase AC grid is a 208 V grid or a 400 V grid.

A high flexibility is a general advantage of the proposed circuit device: As described above, it may serve for a plurality of purposes. A first purpose is the transfer of energy from a source of a direct input voltage, preferentially of a sustainable source, such as a wind power generator or a photovoltaic module to a DC load. A second purpose is the transfer of energy from a source of a direct input voltage, preferentially of a sustainable source, such as a fuel cell or a photovoltaic module and a source of an alternating voltage, preferentially of a single or a multi phase grid, to a DC load. In this embodiment, the circuit device comprises the above mentioned single or multi phase inverter operating as a rectifier. A third purpose is the transfer of energy from a source of a direct input voltage, preferentially of a sustainable source, such as a fuel cell or a photovoltaic module to an AC load, such as an AC grid. Also in this embodiment, the circuit device comprises the above mentioned single or multi phase inverter operating as an inverter. Therefore, the proposed circuit device can serve all these purposes without having to be altered in its set-up.

The magnitude of the direct input voltage may vary depending on the AC mains voltage of the geographic location of the circuit device. A typical value of the magnitude of the direct input voltage may be in between 200 V and 400 V or in between 350 V and 700 V. A typical value of the magnitude of the direct output voltage may be in between 175 V and 200 V or in between 350 V and 400 V. The circuit device of the present invention is suitable to be dimensioned for converting a broad range of rated power, such as in between 1 kW and 1 MW. However, the rated power of the circuit device of the present invention may be smaller than 1 kW or greater than 1 MW.

In the following, further advantageous embodiments of the electrical energy conversion circuit device and its circuit topology are described. For a more detailed description of the circuit topology and the advantages of the below described buck-boost converter and its control, reference is made to the following publication of the same inventor. U. Boeke: “Transformer-less converter concept for a grid-connection of thin-film photovoltaic modules”, Proceedings of the IEEE Industry Application Society meeting, 2008.

In a preferred embodiment, the first and the second buck-boost converter of the electrical energy conversion circuit device are active clamped buck-boost converters. This embodiment has the advantage of further reduced switching losses of the first and the second buck boost converter. Therefore, the efficiency of the circuit device is increased. In addition, a reduction of electromagnetic interference is achieved, which results in a more reliable operation of the circuit device.

In a further preferred embodiment of the electrical energy conversion circuit, the first active clamped buck-boost converter comprises:
a first switching leg with a first switch and a first auxiliary switch connected in series with each other,
a first choke connected between a first contact node and a second contact node between the first switch and the first auxiliary switch of the first switching leg, the first choke being separated into two first serial connected chokes, wherein a node between the two first serial connected chokes is connected to a forth contact node of the electrical energy conversion circuit device via a first diode.

In this embodiment, the second active clamped buck-boost converter comprises:
a second switching leg with a second switch and a second auxiliary switch connected in series with each other,
a second choke connected between the first contact node and a third contact node between the second switch and the second auxiliary switch of the second switching leg, the second choke being separated into two second serial connected chokes, wherein a node between the two second serial connected chokes is connected to the forth contact node via a second diode and wherein the first and the second switching leg are connected in parallel to each other.

In this embodiment, the electrical energy conversion circuit device further comprises:
a clamping capacitor connected in series with the parallel connected first and second switching leg, the series connection of the clamping capacitor and the parallel connected first and second switching leg being connected between the positive contact and the forth contact node, wherein the output capacitor is connected between the first and the forth contact node.

The first diode is arranged such that the cathode of the first diode is connected to the node between the two first serial connected chokes and the anode of the first diode is connected to the forth contact node. Correspondingly, the second diode is arranged such that the cathode of the second diode is connected to the node between the two second serial connected chokes and the anode of the second diode is connected to the forth contact node.

This preferred embodiment has an advantageous topology for realizing efficient and zero-voltage switching, active clamped first and second buck-boost converters.

The first and the second switch and the first and second auxiliary switch are preferentially switched at zero voltage, such that switching losses are furthermore reduced.

The circuit topology of this embodiment has the further advantage that a peak voltage of a respective switch of both the first and the second buck-boost converter is clamped to an internal direct voltage, namely to the sum of the direct input voltage, the direct output voltage and a voltage across the clamping capacitor. Therefore, transients over voltage are reduced during operation of the switches of the first and the second buck-boost converter. In the following, the voltage across the clamping capacitor is also referred to as clamping voltage.

The first and the second diode are adapted to operate with limited rate of change of current which reduces reverse recovery losses in these diodes. Furthermore, the rate of change of the voltage across the switches of the first and the second buck-boost converter is reduced. Therefore electromagnetic interference of the circuit device is reduced.

In a preferred embodiment, the controller of the circuit device is adapted to control both the internal clamping voltage as well as a direct output voltage, preferentially by using duty cycle and switching frequency as independent control parameters. Thus, the voltage across the clamping capacitor does not exceed a certain limit. Therefore, voltage across the switches of switching legs is limited, too. In that context, the circuit device of the present invention could also be referred to as a dual-output controlled converter.

In yet a preferred embodiment, the first contact node is connected to the common contact of constant potential. In this embodiment, the negative contact and the forth contact node refer to a same contact. This embodiment has the advantage that the second output voltage of high magnitude is produced, namely the voltage across the positive contact and the forth contact node or, respectively, the negative contact. As already described above, the second output voltage is advantageously processed by further circuit means, such as a single or multi phase inverter connected downstream of the first and the second active clamped buck-boost converter.

In a preferred embodiment of the electrical energy conversion circuit device, the controller comprises:
a first control signal providing unit adapted to provide the first control signal to the first switch and a first auxiliary control signal to the first auxiliary switch of the first switching leg in dependence of a measured first intermediate current, a measured clamping voltage of the clamping capacitor and a measured direct output voltage,
a second control signal providing unit adapted to provide the second control signal to the second switch and a second auxiliary control signal to the second auxiliary switch of the second switching leg in dependence of a measured second intermediate current and at least one of the first control signal and the first auxiliary control signal.

In this embodiment of the circuit device, the controller set-up corresponds to a master-slave configuration. This is advantageous since the effort for controlling the second buck-boost converter is very low: The controller is adapted to derive the second control signals for controlling the second buck-boost converter from at least one of the first control signals and the second intermediate current. Therefore, for controlling the second buck-boost converter, the controller of the first buck-boost converter has only to be further equipped with a measurement device for capturing the second intermediate current and low complex logic modules, such as a comparator and a Flip-Flop.

In this embodiment, the circuit device preferentially operates at a switching frequency that is a function of a measured direct input voltage, the measured direct output voltage and a measured power transferred via the circuit device. The switching frequency is therefore not fixed to a certain value but may vary according to the above mentioned interrelation. In this embodiment of the present invention, the circuit device operates as a quasi self-oscillating power supply. This has the advantage that no additional oscillator generating a fixed switching frequency has to be provided. Also, the switching pattern does not have to be adapted to a fixed frequency but is adapted to the varying switching frequency. In particular, the phase-shift between the first and the second intermediate current is not limited to 180°, but variable.

In most embodiments of the circuit device, the controller is preferentially adapted to regulate the clamping voltage as well as the direct output voltage by means of varying the switching frequency and/or duty cycle of the first and the second buck-boost converter.

In a preferred embodiment of the electrical energy conversion circuit device, the first and the second buck-boost converter each comprise a metal-oxide-semiconductor-field-effect-transistor (MOSFET). A MOSFET is preferentially employed for a small direct input and a small direct output voltage. For instance, a MOSFET is employed if the direct voltages do not exceed 1000 V.

In another preferred embodiment of the electrical energy conversion circuit device, the first and the second buck-boost converter each comprise an insulated-gate-bipolar transistor (IGBT). An IGBT is preferentially employed for larger direct input and a small direct output voltage. For instance, an IGBT is employed if the direct voltages do exceed 1000 V.

In another preferred embodiment of the electrical energy conversion circuit device, the first and the second buck-boost converter each comprise a silicon-carbide- (SiC-) semiconductor switch, for instance a SiC-MOSFET. A SiC-semiconductor switch has the advantage of very low switching losses.

However, the choice of an employed semiconductor switch is usually dependent on a result of on overall consideration of costs of the circuit device and/or desired efficiency of the circuit device and/or voltage, current and power ratings of the circuit device.

In a second aspect of the present invention an electrical apparatus is presented, wherein the electrical apparatus comprises:
an electrical energy source adapted to generate a first direct voltage;
the electrical energy conversion circuit device of first aspect of the invention for converting the first direct voltage into an output voltage;
outputting means for outputting the output voltage to an electrical consumption unit.

Preferentially, the electrical energy source is a photovoltaic module. In another preferred embodiment of the electrical apparatus, the electrical energy source is a fuel cell.

The electrical consumption unit may be integrated in the electrical apparatus.

In one embodiment, the electrical consumption unit is a personal computer, such as a laptop, a mobile phone, a personal organizer, a digital camera or the like which is electrically supplied by a fuel cell and the electrical energy conversion circuit device connected downstream of the fuel cell.

The output voltage of the electrical apparatus may either be the direct output voltage of the electrical energy conversion circuit device of first aspect of the invention, the second output voltage of the electrical energy conversion circuit device or an output voltage of a single or multi phase inverter connected downstream of the parallel connected first and second buck-boost converter of the electrical energy conversion circuit device.

In a third aspect of the present invention a method of operating an electrical energy conversion circuit device for converting a direct input voltage into a direct output voltage is presented, wherein the methods comprises steps of:
receiving the direct input voltage via a positive contact and a common contact of constant potential of the electrical energy conversion circuit device,
generating a first intermediate current with means of a first buck-boost converter of the electrical energy conversion circuit device in dependence of a first control signal,
generating a second intermediate current with means of a second buck-boost converter connected in parallel to the first buck-boost converter in dependence of a second control signal,
receiving the first and the second intermediate current with means of an output capacitor of the electrical energy conversion circuit device, thereby generating the direct output voltage,
providing the first control signal and the second control signal such that the first and the second intermediate current are phase shifted to each other, thereby regulating the direct output voltage in magnitude.

In a forth aspect of the present invention a computer program for converting a direct input voltage into a direct output voltage is presented, wherein the computer program comprises comprising program code means for causing the electrical energy conversion circuit device of the first aspect of the invention to carry out the steps of the method of the third aspect of the invention, when the computer program is run on computer controlling the electrical energy conversion circuit device.

It shall be understood that electrical energy conversion circuit device of the first aspect of the invention, the electrical apparatus of the second aspect of the invention, the method of the third aspect of the invention of operating an electrical energy conversion circuit device and the computer program of the forth aspect of the invention have similar and/or identical preferred embodiments, in particular, as defined in the dependent claims.

It shall be understood that a preferred embodiment of the invention can also be any combination of the dependent claims with the respective independent claim.

These and other aspects of the invention will be apparent from and elucidated with reference to the embodiments described hereinafter.

### BRIEF DESCRIPTION OF THE DRAWINGS

In the following drawings:

FIG. 1 shows schematically and exemplarily a representation of a circuit topology of a power stage of the electrical energy conversion circuit device comprising a single phase inverter in accordance with the first aspect of the invention,

FIG. 2 shows schematically and exemplarily a representation of the electrical energy conversion circuit device comprising a three phase inverter in accordance with the first aspect of the invention,

FIG. 3 shows schematically and exemplarily a representation of a circuit topology of the controller of the electrical energy conversion circuit device in accordance with the first aspect of the invention,

FIG. 4 shows schematically and exemplarily a graphical representation of currents in the electrical energy conversion circuit device in dependence of a corresponding control signal flow for one switching period,

FIG. 5 shows schematically and exemplarily a representation of the electrical apparatus according to the second aspect of the invention and

FIG. 6 shows exemplarily a flowchart illustrating an embodiment of the method of the third aspect of the invention.

### DETAILED DESCRIPTION OF EMBODIMENTS

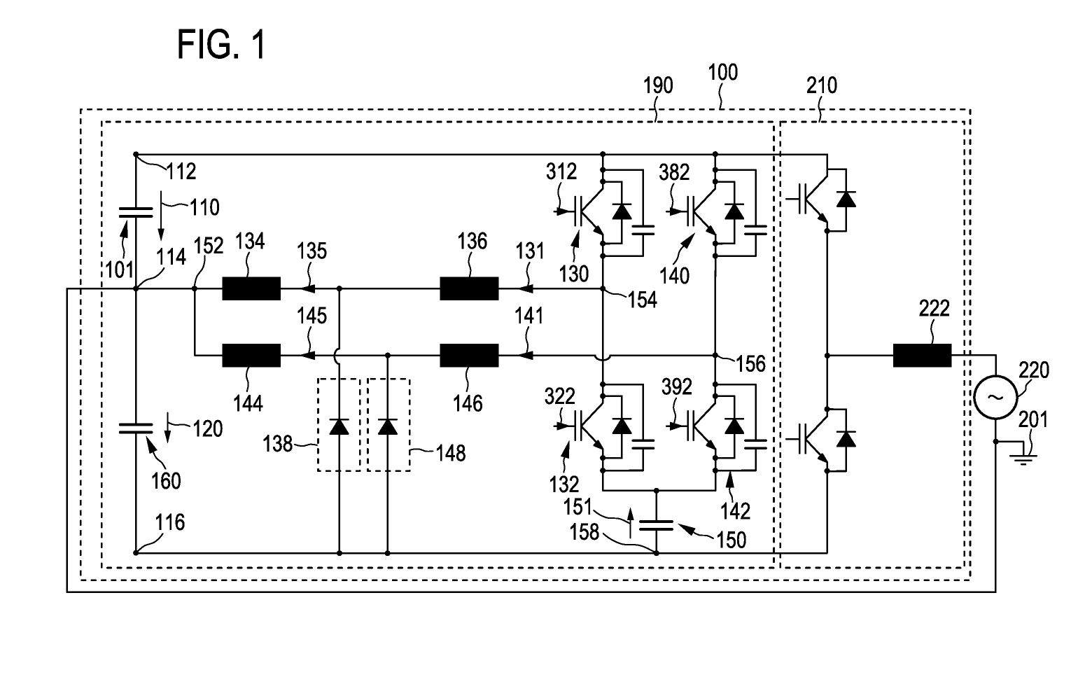

FIG. 1 shows schematically and exemplarily a representation of a circuit topology 100 of a power stage of the electrical energy conversion circuit device comprising a single phase inverter 210 in accordance with the first aspect of the invention. The circuit device 100 comprises the positive contact 112 and the common contact 114 of constant potential for receiving the direct input voltage 110.

The direct input voltage 110 may be supplied by any appropriate source (not shown in FIG. 1), for example by a fuel cell, by a rectifier connected upstream of the circuit device, a battery, or any generator of a direct voltage. In one embodiment, the direct input voltage 110 is supplied by a photovoltaic module. In most cases, there is connected an input capacitor 101 between the positive contact 112 and the common contact 114. The input capacitor 101 may either come as an external capacitor connected between the source and the circuit device or alternatively as an integrated output capacitor of the source or, respectively, as an internal input capacitor 101 of the electrical energy conversion circuit device 100. It is also possible that both the source comprises an integrated output capacitor and the circuit device 100 comprises an internal input capacitor 101 that act together as the input capacitor.

The circuit device 100 comprises the output capacitor 160, which generates the direct output voltage 120. The output capacitor 160 is connected between the common contact 114 and the negative contact 116 of the electrical energy conversion circuit device 100 and the generated direct output voltage 120 is of opposite polarity compared to the polarity of the direct input voltage 110.

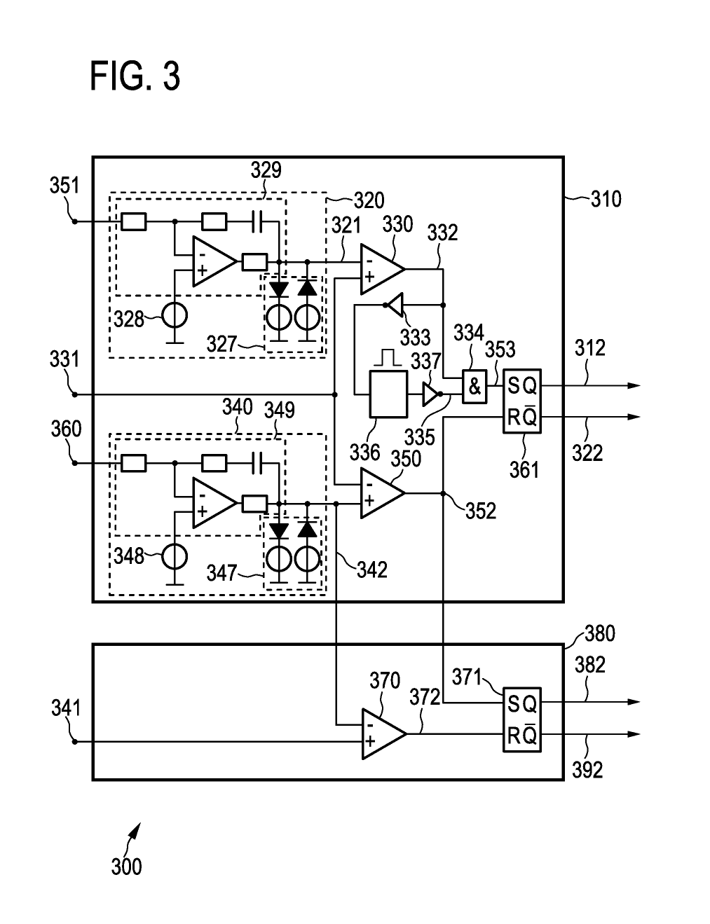

The circuit device 100 comprises two parallel connected buck-boost converters connected to the positive contact 112 and the common contact 114 and adapted to generate the first 131 and the second intermediate current 141 in dependence of the first 312 and the second control signal 382 provided by the controller 300 shown in FIG. 3 (and not shown in FIG. 1).

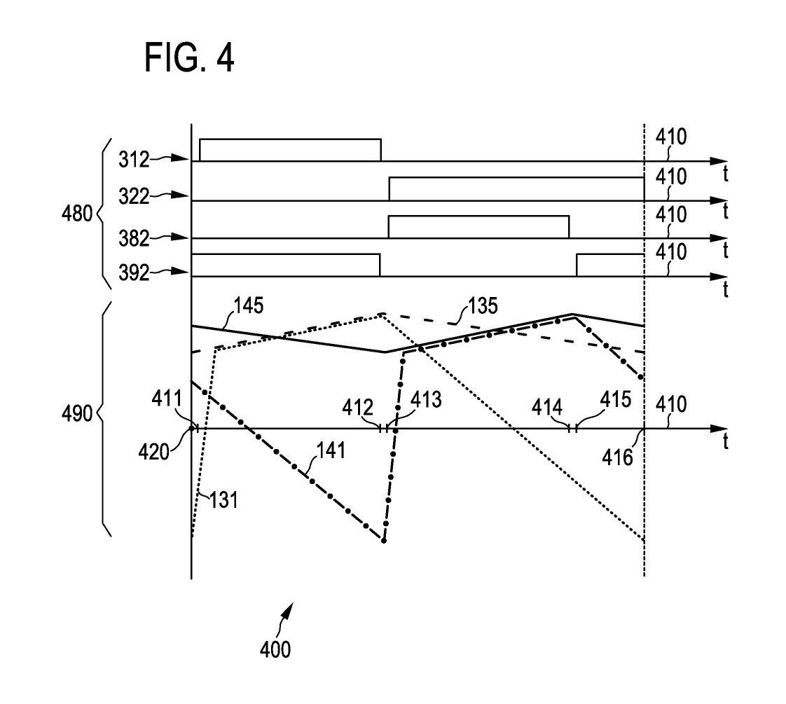

For the sake of an appropriate illustration of the invention, the controller stage and the power stage of the circuit device are shown in separate Figures. Control of the circuit device is described below with respect to FIG. 3 and FIG. 4.

In FIG. 1, the first and the second buck-boost converter are active clamped buck boost converters.

The first active clamped buck-boost converter is realized by means of the following components: The first switching leg 130, 132 with the first switch 130 and the first auxiliary switch 132 connected in series with each other; the first choke 134, 136 connected between the first contact node 152 and the second contact node 154 between the first switch 130 and the first auxiliary switch 132, wherein the first choke 134, 136 is separated into two serial connected chokes 134, 136 and wherein a node between the two chokes is connected to the negative contact 116 via the first diode 138.

In the embodiment of the circuit device 100 shown in FIG. 1, a switch and an auxiliary switch each comprise a power semiconductor with an internal or external anti-parallel diode and an internal or external snubber capacitance. A respective snubber capacitance can be realized by an already existent parasitic capacitance or an added capacitor.

The second active clamped buck-boost converter connected in parallel to the first active clamped buck-boost converter is substantially identical in respect to its set-up and realized by means of the following components: The second switching leg 140, 142 with the second switch 140 and the second auxiliary switch 142 connected in series with each other; the second choke 144, 146 connected between the first contact node 152 and the third contact node 156 between the second switch 140 and the second auxiliary switch 142, wherein the second choke 144, 146 is separated into two serial connected chokes 144, 146 and wherein a node between the two chokes is connected to the negative contact 116 via the second diode 148.

The first and the second switching leg are connected in parallel to each other. The clamping capacitor 150 is connected in series with the parallel connected first and second switching leg is part of both the first and the second buck-boost converter. The series connection of the clamping capacitor 150 and the parallel connected first and second switching leg is arranged between the positive contact 112 and the negative contact 116 of the electrical energy conversion circuit device 100.

As already explained above, the first buck-boost converter generates the first intermediate current 131 in dependence of the first control signal 312 provided by the controller 300 and the second buck-boost converter generates the second intermediate current 141 in dependence of the second control signal 382, wherein the first 131 and the second intermediate current 141 are phase shifted to each other.

The output capacitor 160 is adapted to receive the first 131 and the second intermediate current 141 and to generate the direct output voltage 120 in dependence of the first 131 and the second intermediate current 141.

Since the controller 300 is adapted to control the first and the second buck-boost converter such that the first 131 and the second intermediate current 141 are phase-shifted to each other, a current ripple of the sum of the first and the second intermediate current is reduced. It shall be understood that the circuit device 100 is set up such that the output capacitor 160 receives that sum of the first and the second intermediate current. Due to the phase-shift, during one time period of a switching period, the first intermediate current 131 is rising and the second intermediate current is falling 141. This interleaved operation of the first and the second buck-boost converter has the advantage that a current stress effective at the output capacitor 160 and an input capacitor 101 providing the direct input voltage 110 is reduced by about 60% compared to a single buck-boost converter converting the same amount of power.

Both the first 131 and the second intermediate current 141 originate from the source of the direct input voltage 110, and thereby from the input capacitor 101, and act on circuit components of the buck-boost converters, such as chokes, resistors, capacitors, switches, diodes as well as on the output capacitor 160. Therefore, the reduced current ripple has a plurality of interrelated advantages: First, the losses of the first and the second buck-boost converter are reduced. Second, components of the buck-boost converter do not have to be overdimensioned in order to withstand a high current ripple. Third, ripples of the direct output voltage 120 and the direct input voltage 110 are reduced. Therefore, the capacitances of the output capacitor 160 and/or the input capacitor 101 can be reduced, resulting in smaller and therefore more inexpensive capacitors. These effects of the reduced current ripple also result in an increased lifetime of the circuit device.

The circuit device 100 is advantageously used for supplying a direct current (DC) load (not shown in FIG. 1), such as a local DC grid, connected to the output capacitor 160 of the circuit device 100. Such DC grids are in particular present in households or transportation vehicles, such as cars, trains, ships and aircrafts.

The circuit device 100 depicted in FIG. 1 additionally comprises a single phase inverter 210 connected downstream of the parallel connected first and second buck-boost converter between the positive contact 112 and the negative contact 116. This is advantageous since the circuit device 100 is now adapted to supply electrical energy not only to a DC grid but also to the alternating current (AC) grid 220.

Therefore, if the energy provided by the source of the direct input voltage 110 exceeds the demands of a DC load connected to the output capacitor 160 of the circuit device 100, remaining energy can be supplied to the AC grid 220 connected to the single phase inverter 210.

The AC grid 220 is, for example, a 230 V AC grid or a 120 V AC grid. The single phase inverter 210 is connected to the AC grid 220 via the filtering choke 222 for filtering a high frequency component of an alternating output current of the single phase inverter 210.

The common contact 114 is connected to the neutral contact 201 of the AC grid 220 or, respectively, to ground 201. Since the single phase inverter 210 is connected between the positive contact 112 and the negative contact 116, its effective input voltage is the sum of the direct input voltage 110 and the direct output voltage 120.

Since the common contact 114 is connected to ground 201, a source providing the input voltage 110 is consequently also connected to ground 201. This has a first advantage that a plurality of different sources can serve as the source for the direct input voltage 110. A second advantage is that a high efficiency of a source of the direct input voltage 110, such as a thin-film photovoltaic module, is achieved. Therefore, the efficiency of an arrangement comprising a source of the direct input voltage 110 and the circuit device 100 is increased.

The first and the second buck-boost converter and the single phase inverter 210 are controlled in a plurality of control modes. In a first control mode, energy is transferred from the source of the direct input voltage 110 to a DC load only. In a second control mode, energy is transferred from the source of the direct input voltage 110 to an AC load, such as the AC grid 220. In a third control mode, energy is transferred from the source of the direct input voltage 110 to the DC load and the AC load.

The single phase inverter 210 of the electrical energy conversion circuit device 100 is adapted to operate as a single phase rectifier. Therefore, the single phase inverter 210 allows a bidirectional energy flow. This is particularly advantageous since a local DC load connected to the output capacitor 160 of the circuit device 100 can be supplied by either the source of the direct input voltage 110 or the AC grid 220 connected to the single phase inverter 210 operating as a single phase rectifier or by both the AC grid and the source of the direct input voltage 110, if the source of the direct input voltage 110 does not supply sufficient energy to the DC load.

Therefore, during a forth control mode, energy is transferred to the DC load connected to the output capacitor 160 from both the source of the direct input voltage 110 and the AC grid 220.

If the single phase inverter 210 operates as an inverter inverting the voltage between the positive contact 112 and the negative contact 116 into an alternating current and supplying energy to the AC grid 220, the single phase inverter 210 is usually current controlled. If the single phase inverter 210 supplies energy to a passive AC load, such as a resistor, it is usually voltage controlled.

In one embodiment, the source of the direct input voltage 110 is a sustainable source, such as a fuel cell, a photovoltaic module, a rectifier connected downstream of a wind turbine. The AC grid is for example a 230 V grid or a 120 V grid.

For a more detailed description of the circuit topology 190 and the advantages of the described buck-boost converter and its control, reference is made to the following publication of the same inventor. U. Boeke: “Transformer-less converter concept for a grid-connection of thin-film photovoltaic modules”, Proceedings of the IEEE Industry Application Society meeting, 2008.

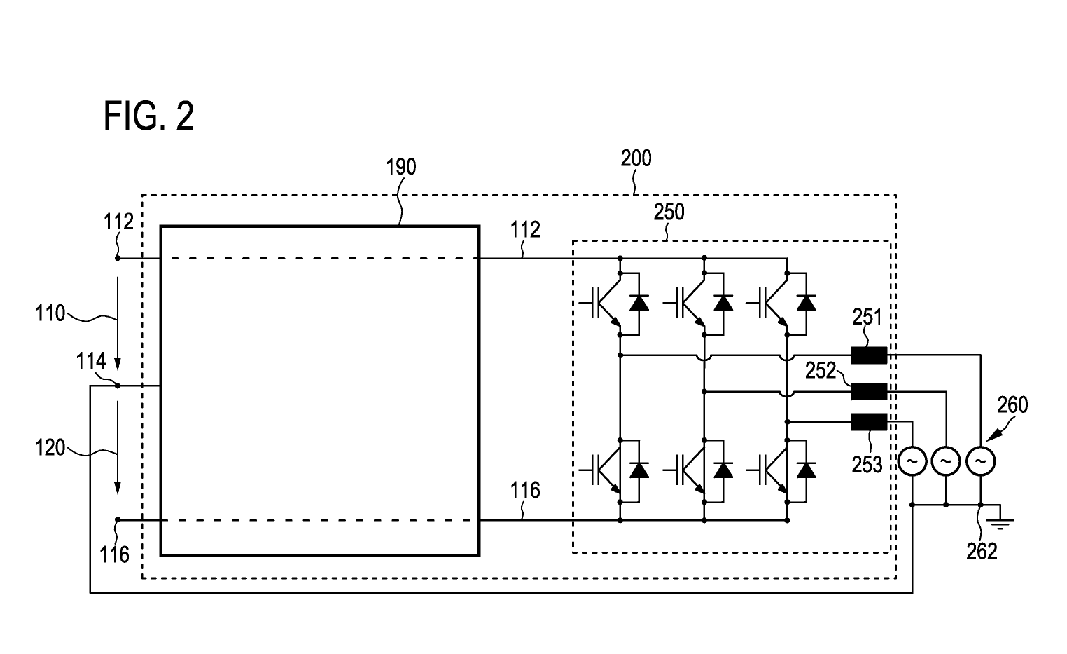

FIG. 2 shows schematically and exemplarily a representation of the electrical energy conversion circuit device 200 comprising a three phase inverter 250 in accordance with the first aspect of the invention. The circuit topology of the circuit block 190 corresponds to that topology of the circuit block 190 depicted in FIG. 1. The three phase inverter 250 is connected to the three phase AC grid 260 by means of three filtering chokes 251, 252, 253. The three phase AC grid 260 is, for instance, a 208 V AC grid or a 400 V AC grid. The neutral point 262 of the AC grid 260 or, respectively, ground 262 is connected to the common contact 114 of the electrical energy conversion circuit device 200. In one embodiment, the three phase inverter 250 is controlled by means of a space vector modulation. The three phase inverter 250 is adapted to operate as a rectifier. If the three phase inverter 250 operates as an inverter inverting the voltage between the positive contact 112 and the negative contact 116 into a three phase alternating voltage and supplying energy to the three phase AC grid 260, the three phase inverter 250 is usually current controlled. If the three phase inverter 250 supplies energy to a passive AC load, such as a resistor, it is usually voltage controlled.

Generally speaking, this embodiment 200 yields similar advantages as the embodiment 100 depicted in FIG. 1 does, where a single phase inverter is arranged. The embodiment 200 of the electrical energy conversion circuit device of FIG. 2 has identical or similar modes of carrying it out as described above.

A local DC load (not shown in FIG. 2) connected to the output capacitor 160 (not shown in FIG. 2) of the circuit device 190 can be supplied by either the source of the direct input voltage 110 or the three phase AC grid 260 connected to the three phase inverter 250 operating as a three phase rectifier or by both the three phase AC grid 260 and the source of the direct input voltage 110.

A high flexibility is a general advantage of the circuit devices 100 and 200: As described above, they may serve for a plurality of purposes. A first purpose is the transfer of energy from the source of the direct input voltage 110, such as a wind power generator, a fuel cell, a photovoltaic module to a DC load. A second purpose is the transfer of energy from the source of the direct input voltage 110 and the single phase grid 220 or, respectively, the three phase grid 260, to a DC load. A third purpose is the transfer of energy from the source of the direct input voltage 110 to the single phase AC grid 220 or, respectively, the three phase AC grid 260. Therefore, the proposed circuit topologies 100 and 200 can serve all these purposes without having to be altered in their respective set-up.

The magnitude of the direct input voltage 110 may vary depending on the AC mains voltage of the geographic location of the circuit device. A typical value of the magnitude of the direct input voltage 110 may be in between 200 V and 400 V or in between 350 V and 400 V. A typical value of the magnitude of the direct output voltage may be in between 175 V and 200 V or in between 350 V and 400 V. The circuit device 190, 100, 200 is suitable to be dimensioned for converting a broad range of rated power, such as in between 1 kW and 1 MW. However, the rated power of the circuit device of the present invention may be smaller than 1 kW or greater than 1 MW.

FIG. 3 shows schematically and exemplarily a representation of a circuit topology of the controller 300 of the electrical energy conversion circuit device 190 in accordance with the first aspect of the invention. The controller is adapted to control the circuit block 190. The controller 300 comprises the first control signal providing unit 310 adapted to provide the first control signal 312 to the first switch 130 and the first auxiliary control signal 322 to the first auxiliary switch 132 of the first switching leg in dependence of the measured first intermediate current 331, the measured clamping voltage 351 of the clamping capacitor 150 and the measured output voltage 360. A measured voltage is a signal that depends on an actual value of the respective voltage. A measured current is a signal that depends on an actual value of the respective current.

The first control signal providing unit 310 receives the measured clamping voltage 351 and generates a clamping voltage regulation signal 321 by means of a first proportional-integral (PI) voltage regulator (first voltage regulator) 320 in dependence of the received measured clamping voltage 351. A first comparator 330 compares the clamping voltage regulation signal 321 with the measured first intermediate current 331 and outputs the first comparison signal 332. Therefore, the first voltage regulator 320 sets a first reference peak value of the first intermediate current by means of the clamping voltage regulation signal 321. Thus, if the first intermediate current reaches its peak value, the first comparison signal 332 output by the first comparator initiates turn-off of the first switch 130 an turn-on of the first auxiliary switch 132 (explained in more detail below).

The first voltage regulator 320 comprises a first inverting amplifier 329, a first reference voltage source 328 and a first limiter circuit 327 which are interconnected to each other according to FIG. 3. The first reference value may be changed in magnitude by altering the voltage of the first reference voltage source 328. The first limiter circuit 327 is adapted to limit the clamping voltage regulation signal 321 in magnitude before it is fed to the first comparator 330. Also, a maximum value of the clamping voltage regulation signal 321 can be set by setting voltage values of the voltage sources of the first limiter circuit 327.

A second proportional-integral voltage regulator (second voltage regulator) 340 of the first control signal providing unit 310 receives the measured direct output voltage 360 and generates a direct output voltage regulation signal 342 in dependence of measured direct output voltage 360. A second comparator 350 compares the direct output voltage regulation signal 342 with the measured first intermediate current 331 and outputs a second comparison signal 352. Therefore, the second voltage regulator 340 sets a second reference peak value of the second intermediate current by means of the direct output voltage regulation signal 342.

The second voltage regulator 340 is substantially equal in topology and functional behavior compared to the first voltage regulator 320. The second voltage regulator comprises a second inverting amplifier 349, a second reference voltage source 348 and a second limiter circuit 347 which are interconnected to each other according to FIG. 3. The second reference value may be changed in magnitude by altering the voltage of the second reference voltage source 348. The second limiter circuit 347 is adapted to limit the direct output voltage regulation signal 342 in magnitude before it is fed to the second comparator 350. Also, a maximum value of the direct output voltage regulation signal 342 can be set by setting voltage values of the voltage sources of the second limiter circuit 347.

The first comparison signal is received by a logic AND-gate 334. The AND-gate 334 further receives a derived signal 335 that is derived from the first comparison signal 332 by means of series connection of a first inverter 333, a one-shot pulse generator 336 and a second inverter 337. The AND-gate 334 outputs a set signal 353.

The first control signal providing unit 310 further comprises a first Flip-Flop 361 that receives both the set signal 353 and the second comparison signal 352. The first Flip-Flop 361 generates the first control signal 312 for operating the first switch 130 of the first buck-boost converter and the first auxiliary control signal 322 for operating the first auxiliary switch 132 of the first buck-boost converter. Therefore, the next set signal 353 for the first Flip-Flop 361 can be generated if the derived signal 335 is high again.

The controller 300 further comprises the second control signal providing unit 380 adapted to provide the second control signal 382 to the second switch 140 and the second auxiliary control signal 392 to the second auxiliary switch 142 of the second switching leg in dependence of the measured second intermediate current 341 and at least one of the direct output voltage regulation signal 342 and the second comparison signal 352.

The second control signal providing unit 380 comprises a third comparator 370 that compares the direct output voltage regulation signal 342 with the measured second intermediate current 341 and outputs a third comparison signal 372. A second Flip-Flop 371 of the second control signal providing unit 380 receives the second comparison signal 352 and the third comparison signal 372. The second Flip-Flop 371 generates the second control signal 382 for operating the second switch 140 of the second buck-boost converter of the circuit device 190 and the second auxiliary control signal 392 for operating the second auxiliary switch 142 of the second buck-boost converter of the circuit device 190.

The set-up of the controller 300 corresponds to a master-slave configuration. This is advantageous since the effort for controlling the second buck-boost converter is very low: The controller 300 is adapted to derive the second control signals 382, 392 for controlling the second buck-boost converter from the second comparison signal 352, the direct output voltage regulation signal 342 and the measured second intermediate current 341. Therefore, for controlling the second buck-boost converter, the controller 310 of the first buck-boost converter has only to be further equipped with a measurement device for capturing the second intermediate current and the low complex logic modules 370 and 371.

It shall be understood the signals 312, 322, 382, 392 for driving switches 130, 132, 140, 142 are usually processed before being fed to the switches. In particular, before being fed to the switches according to FIG. 1, signals 312, 322, 382, 392 shown in FIG. 3 are usually priory fed into a sub-circuit (not shown in the Figures) that generates respective dead-time signals and realizes a level-shift, if necessary.

FIG. 4 shows schematically and exemplarily a graphical representation 400 of currents 490 in the electrical energy conversion circuit device 190 in dependence of a corresponding control signal flow 480 for one switching period. In the following, references are made to FIG. 1, FIG. 3 and FIG. 4 for the sake of clear description.

The graphical representation 400 in FIG. 4 shows five time axes 410. In the upper part 480 of the representation 400, the flow of the control signals 312, 322, 382 and 392 that are provided by the controller 300 is depicted. In the lower part 490 of representation 400, simulated currents 131 and 135 of the first buck-boost converter and simulated currents 141 and 145 of the second buck-boost converter are shown.

The four output signals 312, 322, 382 and 392 that are provided by the controller 300 determine which buck-boost is a master converter and which buck-boost converter is a slave converter. Referring now to FIG. 4 and FIG. 1, the first buck-boost converter comprises the following components: The first diode 138, choke 134 and choke 136, the first switch 130 and the first auxiliary switch 132; the second buck-boost converter comprises the following components: The second diode 148, choke 144 and choke 146, the second switch 140 and the second auxiliary switch 142.

The controller 300 has multiple functions to operate the switches of the first and the second buck-boost converter with suitable control signals 312, 322, 382, 392 such that the direct output voltage 160 is substantially constant and that the clamping voltage 151 does not exceed a certain limit in order to limit a maximum voltage stress of the switches of the first and the second buck-boost converter and to support soft-switching.

The circuit device 190 takes energy from an input capacitor 101 connected between the positive contact 112 and common contact 114 and transfers the energy to the output capacitor 160. The energy stored in the clamping capacitor 150 only changes insignificantly during one switching period. Both the direct input voltage 110 and the direct output voltage 120 can be used to supply the known single-phase inverter 210 or the known three phase inverter 250 to feed electricity into the AC grid 220 or 260.

In one embodiment, the circuit device 190 operates with a switching frequency that is a function of the direct input voltage 110 and the direct output voltage 120, a transferred power and specifications of the components of the circuit device 190. One switching period is illustrated in FIG. 4. The following description of the one switching period considers small parasitic output capacitances of the first 138 and the second diode 148 and of the four switches 130, 132, 140 and 142, such that the voltage at these components changes very fast, once a component is turned off due to the stored energy in the chokes 134, 136, 144 and 146.

At time 420, that is the beginning of one switching period, the first buck-boost converter has finished a discharge period of a previous switching period since first intermediate current 131 has reached its negative peak value. As described above, the first intermediate current 131 is monitored by the first comparator 330 of the controller 300. If the first intermediate current 131 reaches its negative peak value, the first auxiliary switch 132 is turned off and turns on an inverse diode of first switch 130. Furthermore, the first comparison signal 332 output by the first comparator 330 causes the one-shot pulse generator 336 to output the derived signal 335 and generation of the set signal 353 that causes the first Flip-Flop 361 to output the first control signal 312 that turns on the first switch 130 at time 411.

The second buck-boost converter is still in a discharge mode and feeds energy from choke 144 into the output capacitor at the beginning of the switching period, that is at time 420.

After a short but well defined dead-time period, the first switch 130 is turned on at time 411 and the first buck-boost converter starts with a charge period. The current 131 in choke 134 and in choke 136 increases since the turned on first switch 130 connects choke 134 and choke 136 to the direct input voltage 110.

The second buck-boost converter is still in a discharge mode and the second diode 148 conducts the current 145 of choke 144, thereby transferring energy to the output capacitor 160. The second intermediate current 141 in choke 146 decreases since the second auxiliary switch 142 conducts the second intermediate current 141 to the clamping capacitor.

At time 412, the current 135 in choke 134 and the first intermediate current 131 in choke 136 of the first buck-boost converter exceeds a positive peak value, that is set by the second voltage regulator 340. Thus, the second comparator 350 generates a positive second comparison signal 352 that resets the first Flip-Flop 361 and sets the second Flip-Flop 371. Therefore the first switch 130 is turned off. As a result, the first diode 138 becomes conductive which initiates a discharge mode of the first buck-boost converter and the transfer of energy from choke 134 into the output capacitor 160. Also, due to the setting of the second Flip-Flop 371, the first auxiliary switch 132 and the second switch 140 are turned on at time 413, short but well defined after time 412. The turn on of the first auxiliary switch 132 changes a charge of choke 136 to support the soft switching of first switch 130 and the first auxiliary switch 132 with low switching loss.

At time 413, the second switch 140 is turned on which initiates a charge mode of the second buck-boost converter and the transfer of energy from the direct input voltage 110 into choke 144. In that way, energy conversion from the direct input voltage 110 via chokes 134 and 145 into the output is realized in two successive time intervals in combination with significant reduced peak currents and a lower current stress in the input capacitor 101 and the output capacitor 160 compared with the operation of a single buck-boost converter.

At time 414 the current 145 in choke 144 and the second intermediate current 141 in choke 146 of the second buck-boost converter exceeds a positive peak current reference value set by the second voltage regulator 340. Thus, the third comparator 370 generates a positive third comparison signal 372 that ends a charge mode of the second buck-boost converter by generating a resetting the second Flip-Flop 371. The reset second Flip-Flop 371 turns off the second switch 140. As a result, the second diode 148 becomes conductive, thereby initiating a discharge mode of the second buck-boost converter and a transfer of energy from choke 144 into the output capacitor.

At time 415, at a short but well defined dead-time period after time 414, the second auxiliary switch 142 is turned on via the second auxiliary control signal 392. This changes the charge of choke 146 and supports soft switching of the second switch 140 and the second auxiliary switch 142 with low switching loss.

At time 416, that is at that end of the switching period, the first intermediate current 131 in choke 136 of the first buck-boost converter exceeds a negative peak current reference value set by the first voltage regulator 320. This generates the set signal 353, which results in a turn on of the first switch 130 by means of the first control signal 312 at a beginning of a next switching period.

In the above described mode, the circuit device 190 operates as a self oscillating circuit. An additional oscillator circuit is not required. Low power levels result in low peak current reference levels and thus in an unfavorable high switching frequency. The unfavorable high switching frequency is avoided by means of the one-shot pulse generator 336 that realizes a minimum waiting time interval before a new set-signal 353 is transferred to the first Flip-Flop 361 to start with the next switching period.

The one-shot pulse generator 336 is for instance realized by integrated circuit NE555 produced by the firm STMicroelectronics.

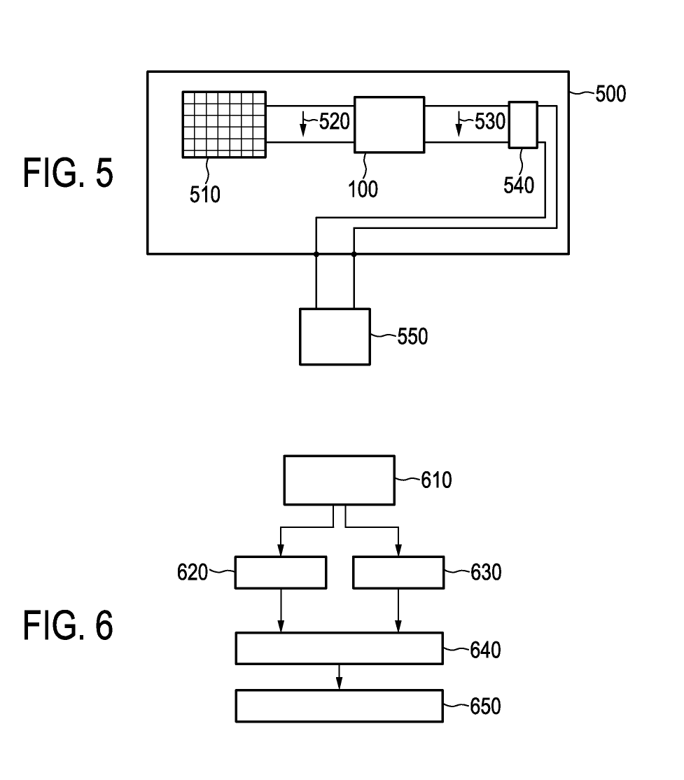

FIG. 5 shows schematically and exemplarily a representation of the electrical apparatus 500 according to the second aspect of the invention. The electrical apparatus 500 comprises the electrical energy source 510 adapted to generate a first direct voltage 520 and the electrical energy conversion circuit device 190, 100 or 200 of first aspect of the invention for converting the first direct voltage into an output voltage 530. Furthermore, the electrical apparatus 500 comprises outputting means 540 for outputting the output voltage to an electrical consumption unit 550.

The electrical energy source 510 is, for instance, a photovoltaic module. In another embodiment of the electrical apparatus 500, the electrical energy source 510 is a fuel cell.

The electrical consumption unit 550 may be integrated in the electrical apparatus.

In one embodiment, the electrical consumption unit 550 is a personal computer, such as a laptop, a mobile phone, a personal organizer, a digital camera or the like which is electrically supplied by the source 510 and the electrical energy conversion circuit device 190, 100, 200 connected downstream of the source 510. As indicated, the circuit device of the apparatus may further comprise a single phase inverter (embodiment 100) or a multiphase inverter (embodiment 200) or may not comprise an inverter (embodiment 190).

The output voltage 530 of the electrical apparatus 500 may either be the direct output voltage of the circuit device 190, the second output voltage of the circuit device 190 or an output voltage of a single or multi phase inverter of the circuit device 100, 200.

The outputting means 540 of the electrical apparatus may comprise further circuit means for processing the output voltage 530, for example filtering means for filtering high frequency components of the output voltage 530. In another embodiment, the outputting means 540 are simply power lines that guide the output voltage 530 to an exterior of the electrical apparatus 500.

FIG. 6 shows exemplarily a flowchart illustrating an embodiment of the method 600 of operating an electrical energy conversion circuit device for converting a direct input voltage into a direct output voltage. In a first step 610, the direct input voltage is received via a positive contact and a common contact of constant potential of the electrical energy conversion circuit device. In a second step 620, 630, a first intermediate current is generated (620) with means of a first buck-boost converter of the electrical energy conversion circuit device in dependence of a first control signal. Also, a second intermediate current is generated (630) with means of a second buck-boost converter connected in parallel to the first buck-boost converter in dependence of a second control signal. In a third step 640, the first and the second intermediate current are received with means of an output capacitor of the electrical energy conversion circuit device. Thereby the direct output voltage is generated. In a forth step 650, the first control signal and the second control signal are provided such that the first and the second intermediate current are phase shifted to each other. Thereby the direct output voltage is regulated in magnitude.

It shall be understood that the above described steps of the method 600 can be executed in an order deviating from the order described above. Some or all steps can be performed simultaneously, for instance steps 620, 630 and 650.

In the above described embodiments, certain control modes are described for controlling the first and the second buck-boost converter in combination with or without a single phase inverter or the multiphase inverter connected downstream of them. In other embodiments, other control methods are employed.

Also in the description above, a single phase and a multi phase inverter are named as possible circuit means to be connected downstream of the parallel connected first and second buck-boost converters. In other embodiments, further or different circuit means are connected downstream of the circuit device, such as insulating means like a transformer.

Furthermore, in the description above, a fuel cell and a photovoltaic module are named as possible sources of the direct input voltage. It is emphasized, that a thin-film photovoltaic module is a suitable source of the direct input voltage. In other application, different sources are provided, such as batteries or circuit means connected upstream of the circuit device.

In particular, the circuit device can comprise an alternative arrangement and/or an alternative set-up of the controller as described above in FIG. 1, FIG. 2, FIG. 3 and FIG. 4. For example, the first and the second buck boost converter can also be a resonant buck-boost converters.

Other variations to the disclosed embodiments can be understood and effected by those skilled in the art in practicing the claimed invention, from a study of the drawings, the disclosure, and the appended claims.

It shall be understood that an arrangement of elements of a respective figure predominately serves a purpose of an evident description; it does not relate to any actual geometric arrangement of parts of a manufactured device according to the invention. Referring in particular to the circuit device, the described inverters can be installed inside the circuit device are be arranged in close or far distance to the circuit device.

The computer program of the forth aspect of the invention may be stored/distributed on a suitable medium, such as an optical storage medium or a solid-state medium supplied together with or as part of other hardware, but may also be distributed in other forms, such as via the Internet or other wired or wireless telecommunication systems.

In the claims, the word “comprising” does not exclude other elements or steps, and the indefinite article “a” or “an” does not exclude a plurality.

A single unit or device may fulfill the functions of several items recited in the claims. The mere fact that certain measures are recited in mutually different dependent claims does not indicate that a combination of these measures cannot be used to advantage.

Any reference signs in the claims should not be construed as limiting the scope.

The present invention is related to an electrical energy conversion circuit device, a method of operating an electrical energy conversion circuit device, an electrical apparatus and a computer program. The circuit device allows earth connection and comprises two parallel connected buck-boost converters for converting a direct input voltage into a direct output voltage. The converters are adapted to generate two phase-shifted currents that are received by an output capacitor. Due to the phase-shift, a current ripple is reduced. The direct output voltage and the direct input voltage preferentially have a common potential and are of opposite polarities. Therefore, a second voltage of high magnitude, the sum of the direct input voltage and the direct output voltage is also provided.

1. An electrical energy conversion circuit device (190; 100; 200) for converting a direct input voltage (110) into a direct output voltage (120), the electrical energy conversion circuit device (190; 100; 200) comprising:
a positive contact (112) and a common contact (114) of constant potential for receiving the direct input voltage (110),
a first buck-boost converter connected to the positive contact (112) and the common contact (114) and adapted to generate a first intermediate current (131) in dependence of a first control signal (312),
a second buck-boost converter connected in parallel to the first buck-boost converter and adapted to generate a second intermediate current (141) in dependence of a second control signal (382),
an output capacitor (160) adapted to receive the first (131) and the second intermediate current (141) and to generate the direct output voltage (120) in dependence of the first (131) and the second intermediate current (141),
a controller (300) adapted to provide the first control signal (312) and the second control signal (382) such that the first (131) and the second intermediate current (141) are phase shifted to each other, thereby regulating the direct output voltage (120) in magnitude.

2. The electrical energy conversion circuit device (190; 100; 200) of claim 1, wherein the output capacitor (160) is connected between the common contact (114) and a negative contact (116) of the electrical energy conversion circuit device (190; 100; 200) and wherein the generated direct output voltage (120) is of opposite polarity compared to a polarity of the direct input voltage (110).

3. The electrical energy conversion circuit device (100) of claim 2, additionally comprising:
a single phase inverter (210) connected downstream of the parallel connected first and second buck-boost converter between the positive contact (112) and the negative contact (116).

4. The electrical energy conversion circuit device (100) of claim 3, wherein the single phase inverter (210) is adapted to operate as a single phase rectifier.

5. The electrical energy conversion circuit device (200) of claim 2, additionally comprising:
a multi phase inverter (230) connected downstream of the parallel connected first and second buck-boost converter between the positive contact (112) and the negative contact (116).

6. The electrical energy conversion circuit device (200) of claim 5, wherein the multi phase inverter (250) is adapted to operate as a multi phase rectifier.

7. The electrical energy conversion circuit device (190) of claim 1, wherein the first and the second buck-boost converter are active clamped buck-boost converters.

8. The electrical energy conversion circuit device (190) of claim 7, wherein the first active clamped buck-boost converter comprises:
a first switching leg (130, 132) with a first switch (130) and a first auxiliary switch (132) connected in series with each other,
a first choke (134, 136) connected between a first contact node (152) and a second contact node (154) between the first switch (130) and the first auxiliary switch (132) of the first switching leg (130, 132), the first choke (134, 136) being separated into two first serial connected chokes, wherein a node between the two first serial connected chokes is connected to a forth contact node (158) of the electrical energy conversion circuit device (190) via a first diode (138),
and wherein the second active clamped buck-boost converter comprises:
a second switching leg (140, 142) with a second switch (140) and a second auxiliary switch (142) connected in series with each other,
a second choke (144, 146) connected between the first contact node (152) and a third contact node (156) between the second switch (140) and the second auxiliary switch (142) of the second switching leg, the second choke (144, 146) being separated into two second serial connected chokes, wherein a node between the two second serial connected chokes is connected to the forth contact node (158) via a second diode (148),
and wherein the first (130, 132) and the second switching leg (140, 142) are connected in parallel to each other and the electrical energy conversion circuit device (190) further comprises:
a clamping capacitor (150) connected in series with the parallel connected first (130, 132) and second switching leg (140, 142), the series connection of the clamping capacitor (150) and the parallel connected first (130, 132) and second switching leg (140, 142) being connected between the positive contact (112) and the forth contact node (158),
and wherein the output capacitor (160) is connected between the first (152) and the forth contact node (158).

9. The electrical energy conversion circuit device (190) of claim 8, wherein the controller (300) comprises:
a first control signal providing unit (310) adapted to provide the first control signal (312) to the first switch (130) and a first auxiliary control signal (322) to the first auxiliary switch (132) of the first switching leg (130, 132) in dependence of a measured first intermediate current (331), a measured clamping voltage (351) of the clamping capacitor (150) and a measured direct output voltage (360),
a second control signal providing unit (380) adapted to provide the second control signal (382) to the second switch (140) and a second auxiliary control signal (392) to the second auxiliary switch (142) of the second switching leg (140, 142) in dependence of a measured second intermediate current (341) and at least one of the first control signal (312) and the first auxiliary control signal (322).

10. The electrical energy conversion circuit device (190; 100; 200) of claim 1, wherein the first and the second buck-boost converter each comprise a metal-oxide-semiconductor-field-effect-transistor.

11. The electrical energy conversion circuit device (190; 100; 200) of claim 1, wherein the first and the second buck-boost converter each comprise an insulated-gate-bipolar transistor.

12. The electrical energy conversion circuit device (190; 100; 200) of claim 1, wherein the first and the second buck-boost converter each comprise a silicon-carbide-semiconductor switch.

13. An electrical apparatus (500) comprising:
an electrical energy source (510) adapted to generate a first direct voltage (520);
the electrical energy conversion circuit device (190; 100; 200) of claim 1 for converting the first direct voltage (520) into an output voltage (530);
outputting means (540) for outputting the output voltage (530) to an electrical consumption unit (550).

14. A method (600) of operating an electrical energy conversion circuit device for converting a direct input voltage into a direct output voltage, the method comprising steps of:
receiving (610) the direct input voltage via a positive contact and a common contact of constant potential of the electrical energy conversion circuit device,
generating (620) a first intermediate current with means of a first buck-boost converter of the electrical energy conversion circuit device in dependence of a first control signal,
generating (630) a second intermediate current with means of a second buck-boost converter connected in parallel to the first buck-boost converter in dependence of a second control signal,
receiving (640) the first and the second intermediate current with means of an output capacitor of the electrical energy conversion circuit device, thereby generating the direct output voltage,
providing (650) the first control signal and the second control signal such that the first and the second intermediate current are phase shifted to each other, thereby regulating the direct output voltage in magnitude.

15. A computer program for converting a direct input voltage into a direct output voltage, the computer program comprising program code means for causing the electrical energy conversion circuit device as defined in claim 1 to carry out the steps of the method as defined in claim 14, when the computer program is run on computer controlling the electrical energy conversion circuit device.
